(19) United States
(12) Patent Application Publication
(10) Pub. No.: US 2007/0040949 A1
(43) Pub. Date: Feb. 22, 2007

(54) Rotating device for display panel

(75) Inventors: Jui Chiang Lin, Hsinchu (TW); Hung Che Yen, Hsinchu (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/295,528

(22) Filed: Dec. 7, 2005

(30) Foreign Application Priority Data
Aug. 18, 2005 (TW) 094128253

(51) Int. Cl. H04N 5/64

(52) U.S. Cl. 348/837; 248/917

(57) ABSTRACT

A rotating device for display panel comprises a base, a display panel set, a first driver set, and a second driver set. The first and the second driver sets installed on the base can be moved to and fro along a fixed direction. A first and a second guide portions are respectively installed in the first and the second driver sets utilized to be passed through and connected in a first and a second guide grooves disposed on the display panel set so as to form a cam structure; Whereby, when the first and the second driver sets are moved reversely, the display panel set is guided by the cam structure to rotate at an angle clockwise or counterclockwise so as to the driver sets do not need to swing and the deflection of the panel can be smoothly achieved.

This Non-provisional application claims priority under 35 U.S.C. §119(a) on Patent Application No(s). 094128253 filed in Taiwan, Republic of China on Aug. 18, 2005, the entire contents of which are thereby incorporated by reference.

### FIELD OF THE INVENTION

The present invention relates to a rotating device for a display panel, and more particularly to a rotating device capable of deflecting a display panel to the right and left.

### DESCRIPTION OF RELATED ART

As the technologies progress, a display system has already been broadly installed on a dashboard between a driver seat and front passenger seat for a driver or a passenger to realize more information about driving through the display system.

Please refer to FIG. 1. The current display system mounted on vehicles, based on its constituting structure, mainly comprises a mainframe M, a display panel set P and a case C, in which the mainframe M and the display panel set P are respectively accommodated in the case C coordinately inlayed in the dashboard and the display panel set P comprises a movable base P1 and a display P2. A rotating driver set P3 and a driver set (not shown in the figure) are installed on the movable base P1, and the display P2 is pivotally connected to the front end of the movable base P1 and controlled by the rotating driver set P3. Therefore, the display P2 is rotated from a horizontal posture to elevate to a raised posture through the rotating driver set P3 after the movable base P1 is driven by the driver set to move the display P2 out of the case C for allowing the driver or the passenger to read message displayed on the display P2.

When a general LCD display panel is formed perpendicularly to a line of vision as far as possible, the viewing quality is best. But, because the vehicle-mounted display panels mentioned above are all installed on the dashboard between the driver set and the front passenger seat, it cannot be adjusted to match up with the viewing direction of a viewer so that the viewing quality is not good.

Because of that, an apparatus for allowing a display panel to rotate to deflect to the left and right is developed. A typical apparatus such as one disclosed in U.S. Pat. No. 6,731,350 entitled as “Vehicle mounted display system” mainly comprises a first driver set and second driver set serving for driving a movable base to move a display panel into and out of a case; they are respectively engaged with a first and a second racks disposed on chassis to allow the movable base to be moved relatively to the chassis. Whereby, the first and the second driver sets drive the movable base to move when they drive each other synchronically to move the display panel out of the case, and the rotating driver set further elevates the display panel from a horizontal posture to a raised posture. And, when the first driver set and the second driver set are respectively driven in an opposite direction, the movable base is caused to rotate to deflect toward one side so as to attain to the object deflecting the display panel toward one side.

However, the first and the second driver sets disclosed in the patent mentioned above are linearly moved along the first and the second racks on the chassis. For allowing the display panel to deflect to the left and right smoothly, the first and the second driver sets are pivotally connected onto the movable base in the patent mentioned above, and when the display panel is rotated, the first and the second driver sets can be matched with the deflected direction to swing and cause the display panel to deflect toward one side. Therefore, for allowing the first and the second driver sets to keep engaging with the racks incessantly when they are swung, a spring must respectively be installed between each of the driver sets and the movable base to allow the engagement state being kept between each of the driver sets and the rack matched up therewith through the resilient force of the spring when the first and the second driver sets is matched with the deflected direction of the display panel to swing.

However, utilizing the resilient force of the springs to control the engagement states of the driver sets and the racks causes not only the number of the components to be increased, but also the driver sets cannot be engaged with the racks due to the elastic fatigue of the spring. Therefore, it is not a quite ideal structure design to the durability and the production cost.

### SUMMARY OF THE INVENTION

In view of this, one object of the present invention is to provide a rotating device for a display panel, the deflection of the panel can be easily attained through a compact structure without increasing the number of components and the assembly cost.

For attaining the object mentioned above, the present invention proposes a rotating device for a display panel, comprising a base, a display panel set, a first driver set and a second driver set, in which the first and the second driver sets are installed on the base and moved to and fro along a fixed direction, and a first and a second guide portions are respectively installed in the first and the second driver sets, which are respectively passed through and connected in a first and a second guide grooves disposed on the display panel set to form a cam structure. When the first and the second driver sets are moved in an opposite direction, the first and the second guide portions are respectively moved in the guide grooves with respect to the display panel set.

According to the rotating device of the present invention, the display panel set comprises a display panel and a movable base pivotally connected to the display panel; a third driver set serving for driving the display panel to be raised from a horizontal posture to a raise posture is installed on the movable base

According to the rotating device of the present invention, the first and the second driver sets respectively comprises a gear train engaged with a rack disposed on the base and a motor for driving the gear train.

According to the rotating device of the present invention, when the first and the second driver sets are moved synchronically in the same direction, the guide portions push walls of guide grooves to move the display panel set out of the base, and when the first and the second driver sets are respectively moved in an opposite direction, the guide portions push the wall of the guide grooves reversely to rotate the display panel rightward or leftward so as to attain the object of the panel deflection.

According to the rotating device of the present invention, a guide rail is further disposed on the base, and a central bolt is further disposed on the display panel set for guiding the panel to move along the guide rail on the base stably. And, when the first and the second driver sets are moved in an opposite direction, the display panel is rotated clockwise or counterclockwise by taking the central bolt as an axis.

### BRIEF DESCRIPTION OF THE DRAWINGS

The present invention can be more fully understood by reference to the following description and accompanying drawings, in which:

FIG. 1 is a schematic view, showing a conventional vehicle-mounted display system;

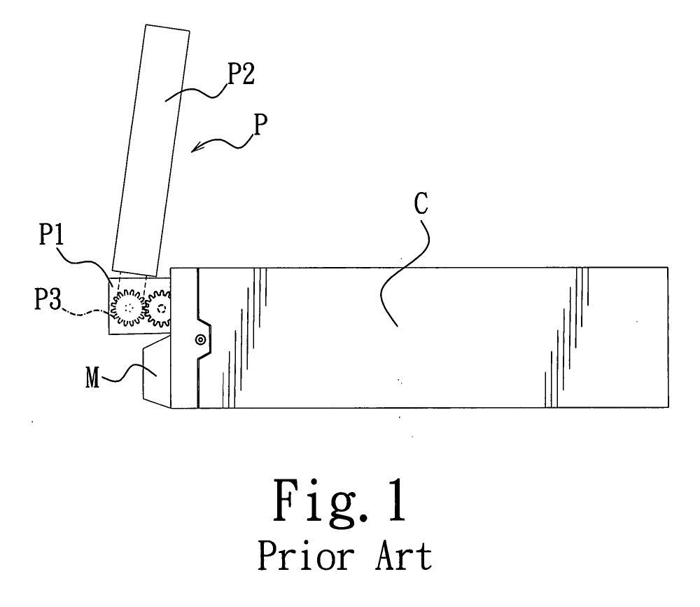

FIG. 2 is an exploded view, showing the rotating device for display panel of one preferred embodiment according to the present invention;

FIG. 3 is an exploded view, showing the first and the second driver sets and the display panel set in FIG. 2;

FIG. 4 is a schematic view, showing the rotating device of display panel of the preferred embodiment according to the present invention, in which the display panel set is not yet moved out of the case;

FIG. 5 is a schematic view, showing the rotating device of display panel of the preferred embodiment according to the present invention, in which the display panel set has already been moved out of the case;

FIG. 6 is a schematic view, showing the rotating device of display panel of the preferred embodiment according to the present invention, in which the display panel is elevated to a raised posture and deflected to the left; and

FIG. 7 is a schematic view, showing the rotating device of display panel of the preferred embodiment according to the present invention, in which the display panel is elevated to a raised posture and deflected to the right.

### DETAILED DESCRIPTION OF THE PREFERRED EMBODIMENTS

According to the objects mentioned above, one preferred embodiment is brought up to explain the technological means adopted in the present invention and the effect thereof accompanying the attached figures.

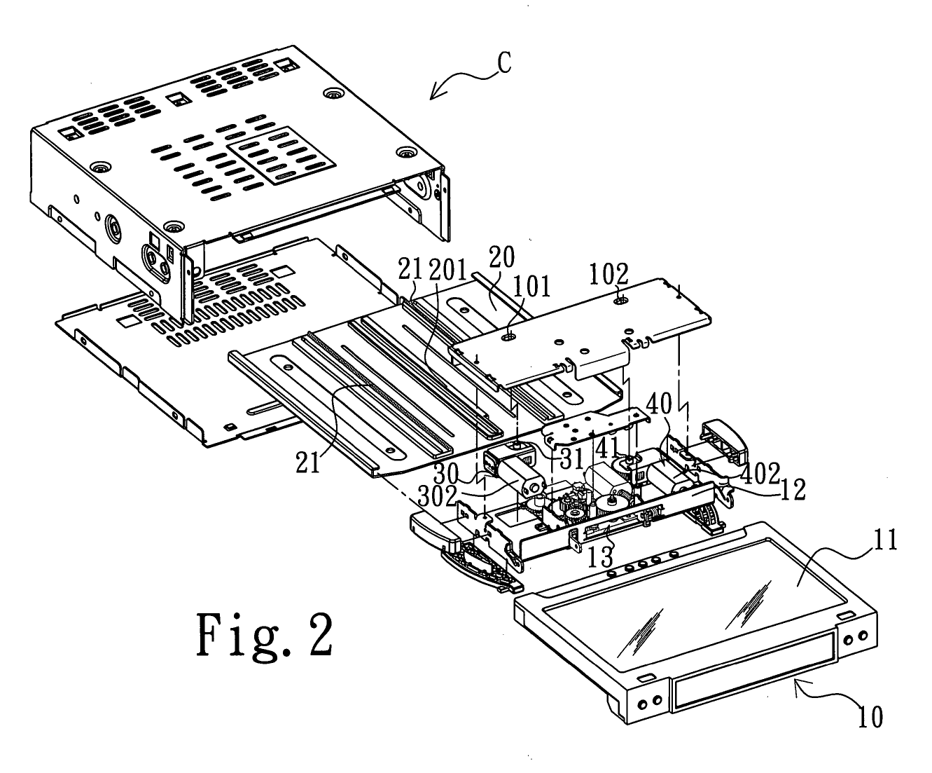

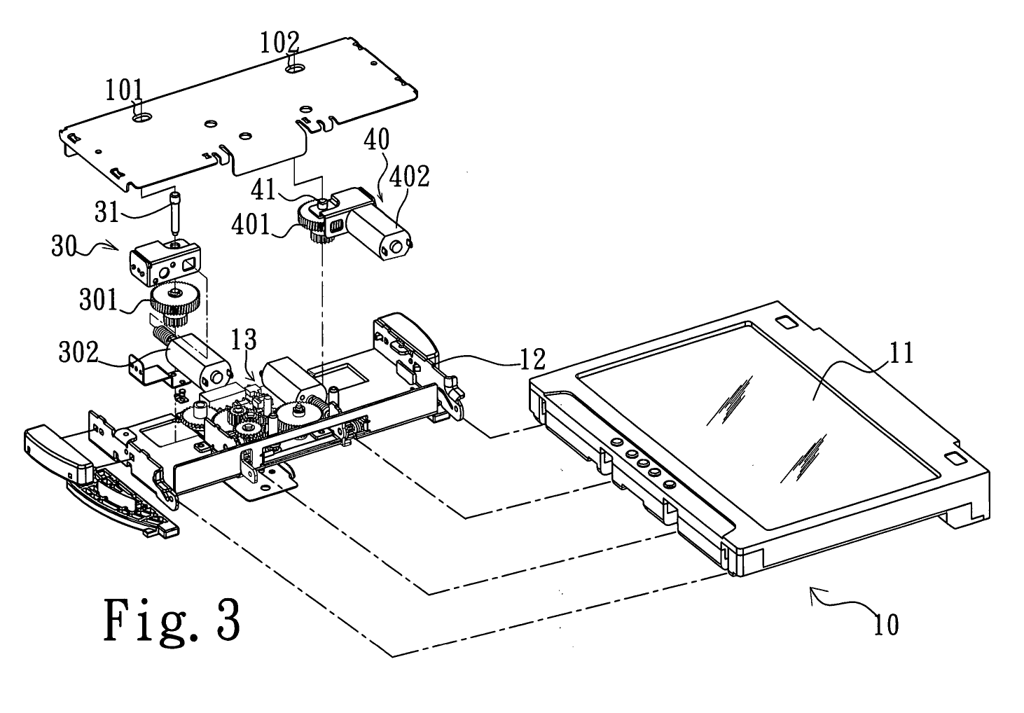

Please refer to FIGS. 2 and 3. FIG. 2 is an exploded view illustrating the rotating device for display panel according to the present invention. FIG. 3 is an exploded view illustrating the first and the second driver sets and the display panel shown in FIG. 2.

As the figures show, the rotating device for display panel according to the present invention serving for rotating the display panel to cause it to deflect an angle so as to allow a driver or a passenger respectively sitting at the left and right sides of a display panel set 10 to have best views to obtain the message displayed on the panel set. The rotating device comprises a display panel set 10, a base 20, a first driver set 30, and a second driver set 40.

The base 20 is installed inside a case C inlayed in a dashboard of a vehicle. A pair of parallel racks 21 is disposed on the surface of the base 20. The racks 21 are respectively engaged with the first and the second driver sets 30 and 40 to allow the first and the second driver sets 30 and 40 to be moved to and fro on the base 20 in a fixed direction. In addition, a guide rail 201 is disposed on the base 20 between the racks 21, 21 serving for guiding the display panel set 10 to be moved stably with the first and the second driver sets 30 and 40 on the base 20.

The first and the second driver sets 30 and 40 respectively comprises gear train sets 301,401 and motors 302, 402 respectively providing power for the gear train sets 301, 401, as FIG. 3 shows. Power outputting ends of the gear train sets 301, 401 are respectively engaged with the racks 21 on the base 20 so that the driver sets 30 and 40 can be moved on the base 20 along the racks 21 by virtue of the driving of the motor 302, 402. Besides, guide portions 31 and 41 are respectively disposed in the first and the second driver sets 30 and 40. Guide grooves 101 and 102 are respectively disposed at the positions on the display panel set 10 corresponding to the guide portions 31, 41 and match with the guide portions 31, 41 to form a cam structure. When the first and the second driver sets 30 and 40 are moved forward synchronically, they respectively push the walls of the guide grooves 101 and 102 through the guide portions 31 and 41 to cause the display panel set 10 to be moved forward with the driver sets out of the case C. And, when the first and the second driver sets 30 and 40 are respectively moved forward and backward in an opposite direction, the walls of the guide grooves 101 and 102 are respectively pushed reversely through the guide portions 31 and 41 in the same way to cause the display panel to be deflected clockwise or anticlockwise. Furthermore, the guide portions 31 and 41 are respectively moved in the guide grooves 101 and 102 with respect to the display panel set 10 such that the first and the second driver sets 30 and 40 need not to match with the rotating direction of the display panel set 10 to swing, the deflection of the panel can then be attained.

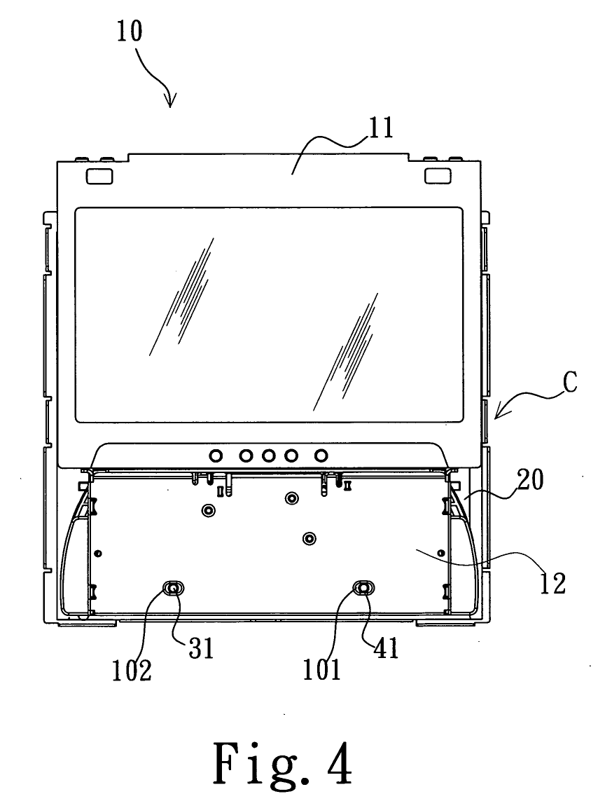

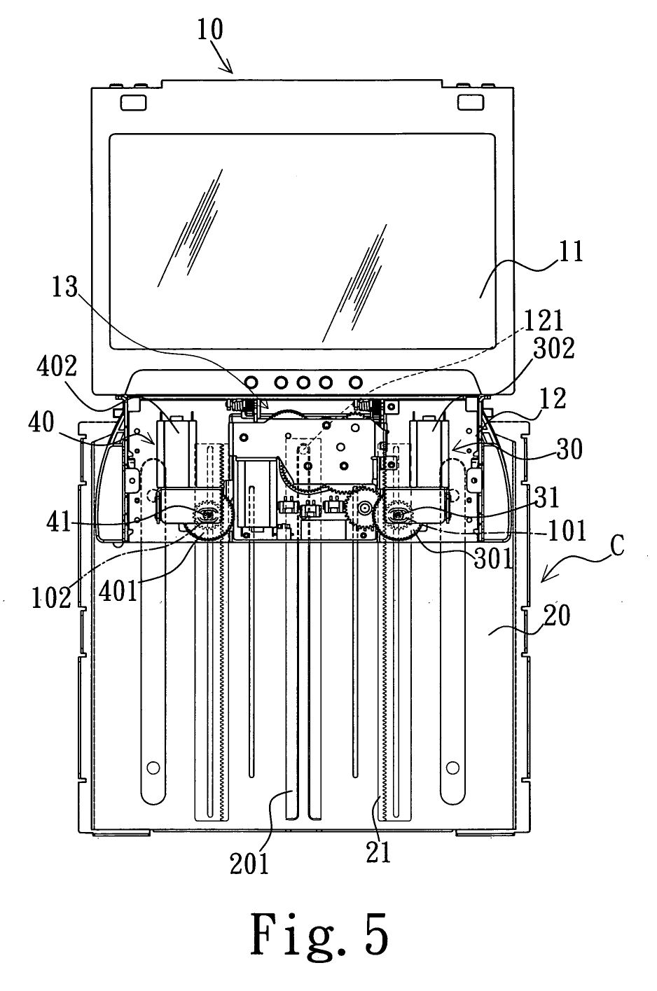

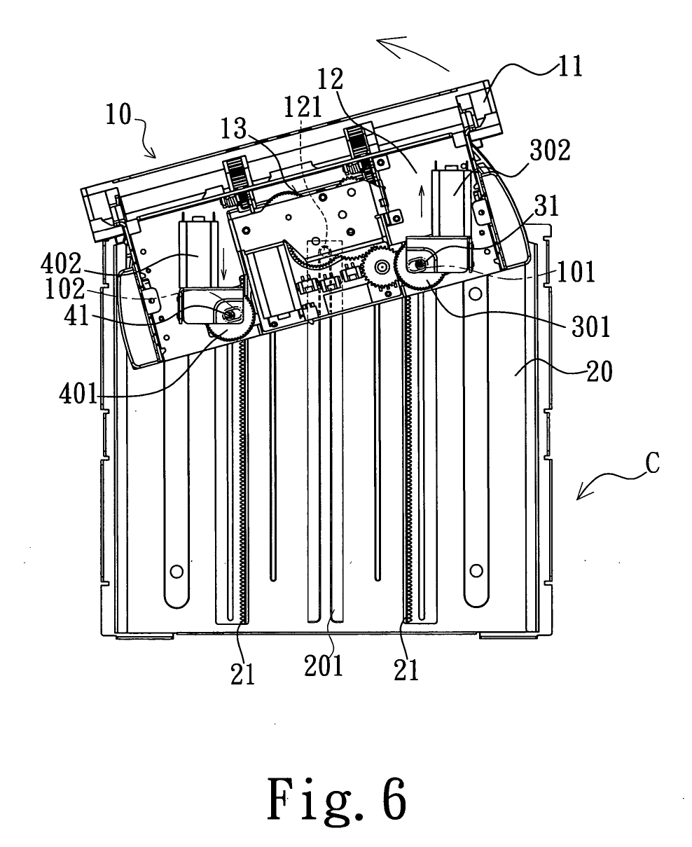

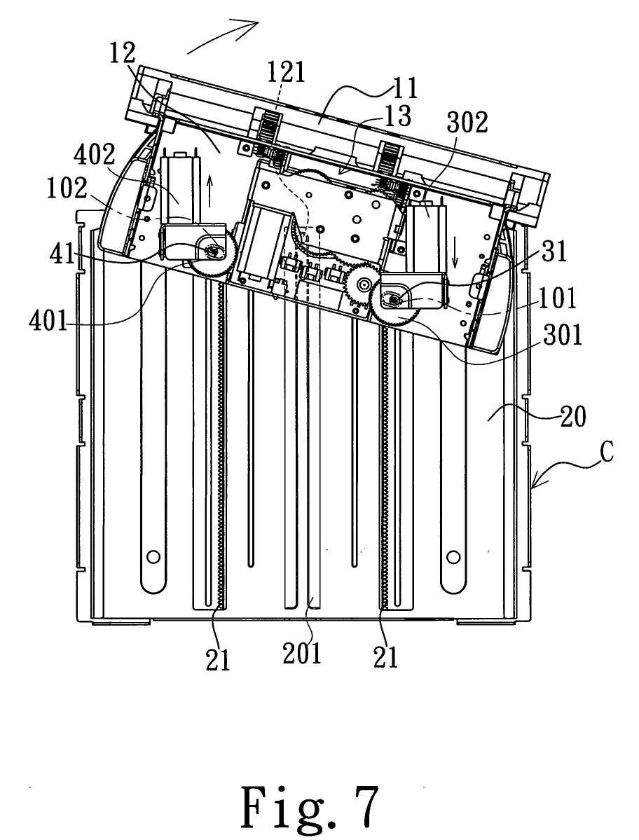

Please refer FIGS. 4 to 7. FIG. 4 is a schematic view showing the rotating device for display panel of the preferred embodiment according to the present invention in which the display panel set is not moved out of a case. FIG. 5 shows a state that the display panel set is moved out of a case, FIG. 6 shows that a display panel is elevated to a raise posture and deflected to the left, and FIG. 7 shows that a display panel is elevated to a raise posture and deflected to the right.

As the figures show, the display panel set 10 comprising a display panel 11 serving for displaying information and a movable base 12 pivotally connected with the display panel 11, and a third driver set 13 is installed on the movable base 12 serving for driving the display panel 11 to be elevated from a horizontal posture to a raised posture. The display panel set 10 is accommodated in the case C before it is not driven, as FIG. 4 shows. And, the guide portions 31 and 41 are respectively positioned at the central positions of the guide grooves 101 and 102. When the display panel set 10 is to be moved out the case C, the first and the second driver sets 30 and 40 are driven synchronically and moved forward in the same direction to move the display panel set 10 out of the case C, as FIG. 5 shows. At this time, the guide portions 31 and 41 are similarly positioned at the central positions of the guide grooves 101 and 102. The first and the second driver sets 30 and 40 are not immediately stopped until the display panel set 10 is moved out of the case, and the third driver set 13 starts to drive the display panel 11 to elevate from a horizontal posture to a raised posture and a user can choose the deflection direction. If a user chooses deflecting the display panel 11 to the left shown in the figure, the first driver set 30 keeps going forward toward a direction that the display panel 11 is moved out previously, and the second driver set 40 is drawn back in an opposite direction and moved reversely with respect to the first driver set 30 to cause the guide portions 31 and 41 installed on the driver sets 30 and 40 to push the guide grooves 101 and 102 engaged therewith in an opposite direction to deflect the display panel set 10 at an angle to the left, as FIG. 6 shows. Meanwhile, the guide portions 31 and 41 are respectively moved in the guide grooves 101 and 102 with respect to the display panel set 10. Vice versa, if the user chooses deflecting the display panel 11 to the right, the second driver set 40 goes forward in a direction that the display panel 11 is moved out previously, and the first driver set 30 is moved reversely with respect to the second driver set 40 in an opposite direction to enable the guide portions 31 and 41 installed on the driver sets to push the guide grooves 101 and 102 engaged therewith respectively in an opposite direction, and the display panel set 10 is rotated to deflect an angle to the right so as to complete the adjustment of the angle of the display panel 11, as FIG. 7 shows. Similarly, when the display panel set 10 is deflected, the guide portions 31 and 41 are respectively moved in the guide grooves 101 and 102 with respect to the display panel set 10.

According to the embodiment of the present invention, a central bolt 121 is disposed on the movable base 12 and is matched with the guide rail 201 on the base 20.

When the first and the second drive sets 30 and 40 are moved forward synchronically, the central bolt 121 is guided by the guide rail 201 to slide therein, and when the first and the second driver sets 30 and 40 are reversely moved respectively in forward and backward directions, the display panel set 10 takes the central bolt 121 as an axis to rotate clockwise or counterclockwise.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A rotating device for display panel, comprising:
a base;
a display panel set, having a first guide groove and a second guide groove;
a first driver set, installed on said base, movable to and fro along a fixed direction, and provided with a first guide portion; and
a second driver set, installed on said base, movable to and fro along a fixed direction, and provided with a second guide portion;
wherein said first and said second guide portions are respectively passed through and connected onto said first and said second guide grooves respectively disposed on said display panel; when said first and said second driver sets are moved in an opposite direction, said first and said second guide portions are respectively moved in said first and said second guide grooves with respect to said display panel set.

2. The rotating device according to claim 1, wherein said display panel set comprises a display panel and a movable base pivotally connected to said display panel, and a third driver is installed on said movable base utilized to drive said display panel elevate from a horizontal posture to a raised posture.

3. The rotating device according to claim 1, wherein a pair of parallel racks is further disposed on said base, respectively engaged with said first and said second driver sets, and said first and said second driver sets is moved on said base along said racks.

4. The rotating device according to claim 1, wherein said first and said second driver sets respectively comprises a gear train engaged with said rack and a motor for driving said gear train.

5. The rotating device according to claim 2, wherein a guide rail is further disposed on said base, and a central bolt matched with said guide rail is further disposed on said movable base; when said first and said second driver set are moved reversely, said display panel set takes said central bolt as an axis to rotate clockwise or counterclockwise.
